(19) United States
(12) Patent Application Publication
(10) Pub. No.: US 2013/0260101 A1
(43) Pub. Date: Oct. 3, 2013

(54) PROTECTIVE DEVICE

(71) Applicant: WEI-LING HONG, TAIPEI HSIEN (TW)

(72) Inventor: WEI-LING HONG, TAIPEI HSIEN (TW)

(73) Assignee: WISTRON CORPORATION, TAIPEI HSIEN (TW)

(21) Appl. No.: 13/603,685

(22) Filed: Sep. 5, 2012

(30) Foreign Application Priority Data
Mar. 27, 2012 (TW) 101110665

(51) Int. Cl. B65D 65/22; B32B 3/30

(52) U.S. Cl. 428/169; 428/188

(57) ABSTRACT

The present disclosure relates to a protective device, which comprises a first protective structure, a second protective structure, and a connecting structure. The connecting structure connects the first, and second protective structures. The flexible object to be protected is disposed in the space between the first and second protective structures. The first protective structure has a minimum bending radius greater than or equal to the tolerable minimum bending radius of the flexible object to be protected. Thereby, when the protective device is bent by force, it can prevent breaks in the flexible object due to over-bending.

### FIELD OF THE DISCLOSURE

The present disclosure relates generally to a protective device, and particularly to a protective device used for protecting flexible objects.

### BACKGROUND OF THE DISCLOSURE

Currently, many devices or apparatuses are connected using flexible objects. For example, two printed circuit boards can be connected by a flexible printed circuit board; electronic devices are connected with power devices or modems using power lines or network wires. These flexible objects have a tolerable minimum bending radius. When the flexible objects are bent below the tolerable minimum bending radius, the flexible objects are prone to breaks or damages.

Most of the present protective devices for flexible objects are non-bendable, Namely, they cannot bend according to the flexible objects. Although a portion of the flexible objects still can be protected, the present protective devices cannot prevent the over-bending situation on the flexible objects. A few protective devices can bend according to the flexible objects. Nonetheless, they are not designed to limit the minimum bending radius to be greater or equal to the tolerable minimum bending radius of the flexible objects, leading to breaks or damages in the flexible object owing to over-bending.

Accordingly, the present disclosure provides a protective device with a minimum bending radius limited to be greater or equal to the tolerable minimum bending radius of the flexible objects for avoiding breaks or damages in the flexible objects due to over-bending.

### SUMMARY

An objective of the present disclosure is to provide a protective device for protecting at least a flexible object. The protective device bends according to the flexible object and prevents breaks or damages in the flexible object due to over-bending.

Another objective of the present disclosure is to provide a protective device, which covers the flexible object for preventing damages caused by collisions with other objects and by pollution from external pollutants.

Still another objective of the present disclosure is to provide a protective device, which can be disposed on the flexible object when both ends of the flexible object are connected to another device, in addition, the flexible object with the protective device installed cart be disassembled from another device directly.

The present disclosure provides a protective device for protecting a flexible object, which comprises a first protective structure, a second protective structure, and a connecting structure. The first protective structure includes a plurality of first protective bodies. The second protective structure includes a plurality of second protective bodies corresponding to the plurality of first protective bodies. The connecting structure connects the first and second protective structures. The first protective structure has a minimum bending radius greater than or equal to the minimum bending radius of the flexible object.

### BRIEF DESCRIPTION OF THE DRAWINGS

FIG. 1 shows a three-dimensional diagram of the protective device according a first embodiment of the present disclosure;

FIG. 2 shows another three-dimensional diagram of the protective device according the first embodiment of the present disclosure;

FIG. 3 shows a side view of the protective device according the first embodiment of the present disclosure;

FIG. 4 shows a side view of the protective device according a second embodiment of the present disclosure;

FIG. 5 shows a three-dimensional diagram of the protective device according a third embodiment of the present disclosure;

FIG. 6 shows a usage status diagram of the protective device according the first embodiment of the present disclosure;

FIG. 7 shows another usage status diagram of the protective device according the first embodiment of the present disclosure;

FIG. 8 shows a three-dimensional diagram of the protective device according a fourth embodiment of the present, disclosure;

FIG. 9 shows a three-dimensional diagram of the protective device according a fifth embodiment of the present disclosure; and

FIG. 10 shows a usage status diagram of the protective device according the fifth embodiment of the present disclosure.

### DETAILED DESCRIPTION

In order to make the structure and characteristics as well as the effectiveness of the present disclosure to be further understood and recognized, the detailed description of the present disclosure is provided as follows along with embodiments and accompanying figures.

While connecting a plurality of devices using a flexible object according to the prior art, although the flexible object is bendable, the tolerable minimum bending radius of the flexible object depends on the material thereof. When the flexible object is over-bent, namely, the bending radius of the flexible object being less than its minimum bending radius, the flexible object is prone to breaks or damages. At present, there is no suitable protective device that can bend according to the flexible object and avoid over-bending. Thereby, the present disclosure provides a protective device for flexible object slipping on the flexible object. The protective device not only prevents accumulation of external pollutants, such as powders, dusts, on the flexible object but also bends according to the flexible object and prevents over-bending of the flexible object.

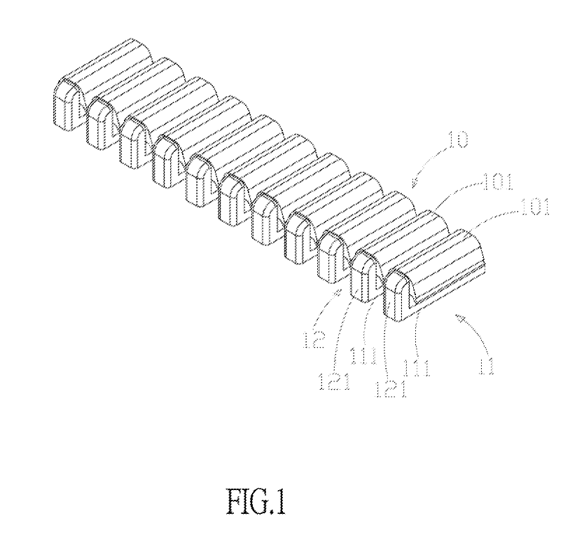

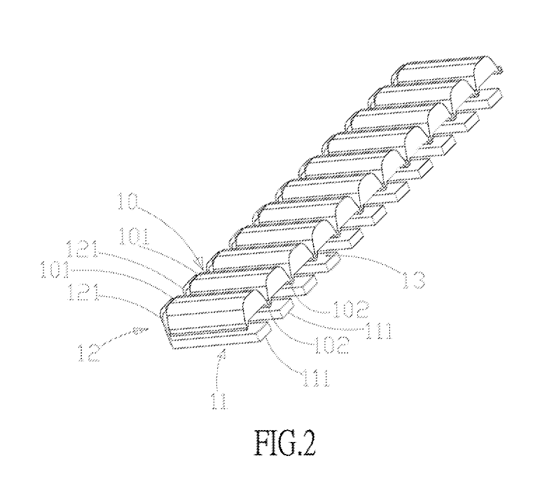

FIG. 1 and FIG. 2 show three-dimensional diagram of the protective device according a first embodiment of the present disclosure. As shown in the figures, the present embodiment provides a protective device 1 for protecting at least a flexible object, such as a flexible printed circuit board connecting two printed circuit board and indoor power lines. The protective device 1 according to the present embodiment comprises a first protective structure 10, a second protective structure 11, and a connecting structure 12, The connecting structure 12 is used for connecting one side of the first and second protective structures 10, 11. When the flexible object is placed from the side of the first and second protective structures 10, 11 without the connecting structure 12, the first and second protective structures 10, 11 will not separate. They cover the flexible object and block external pollutants for preventing accumulation of the external pollutants on the flexible object. The accumulation can lead to pollution from the external pollutants and hence resulting in damages. In addition, the damages caused by collisions of the flexible object with external objects can be avoided as well.

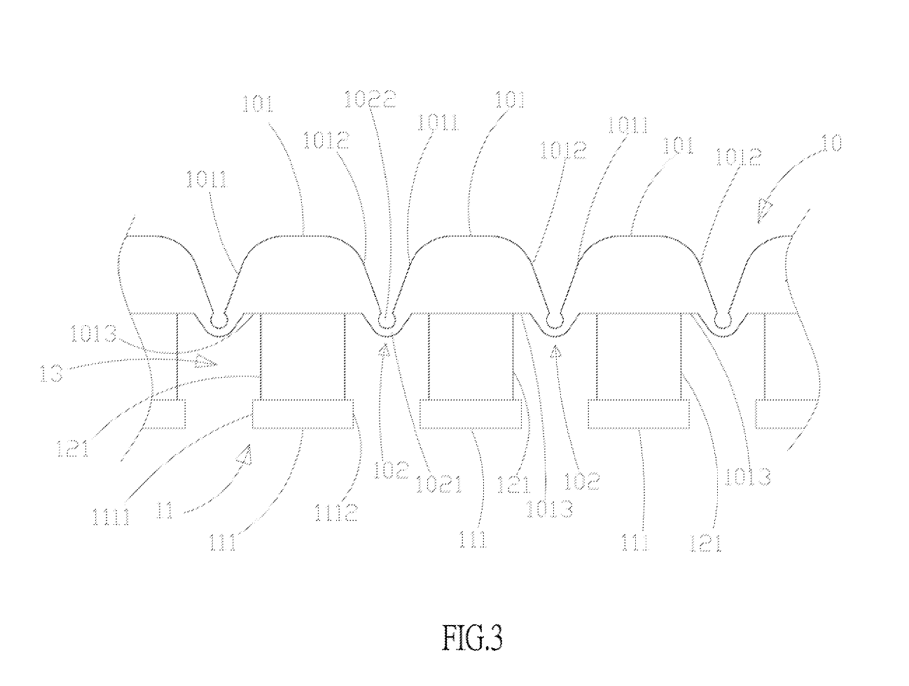

FIG. 3 shows a side view of the protective device according the first embodiment of the present disclosure. As shown in the figure, the first protective structure 10 according to the present embodiment includes a plurality of first protective bodies 101 and a plurality of connecting parts 102. Each first protective body 101 has a first side surface 1011 and a second side surface 1012 corresponding to the first side surface 1011. The plurality of first protective bodies 101 are arranged linearly. The plurality of connecting parts 102 connect the plurality of first protective bodies 101. For example, the first side surface 1011 of the first protective body 101 located at the center corresponds to the second side surface 1012 of the first protective body 101 located on the left; the second side surface 1012 of the first protective body 101 located at the center corresponds to the first side surface 1011 of the first protective body 101 located on the right; the first protective body 101 at the center connects with the first protective body 101 on the left and on the right: via the connecting parts 102, respectively. The plurality of first protective bodies 101 and the plurality of connecting parts 102 according to the present embodiment are formed integrally.

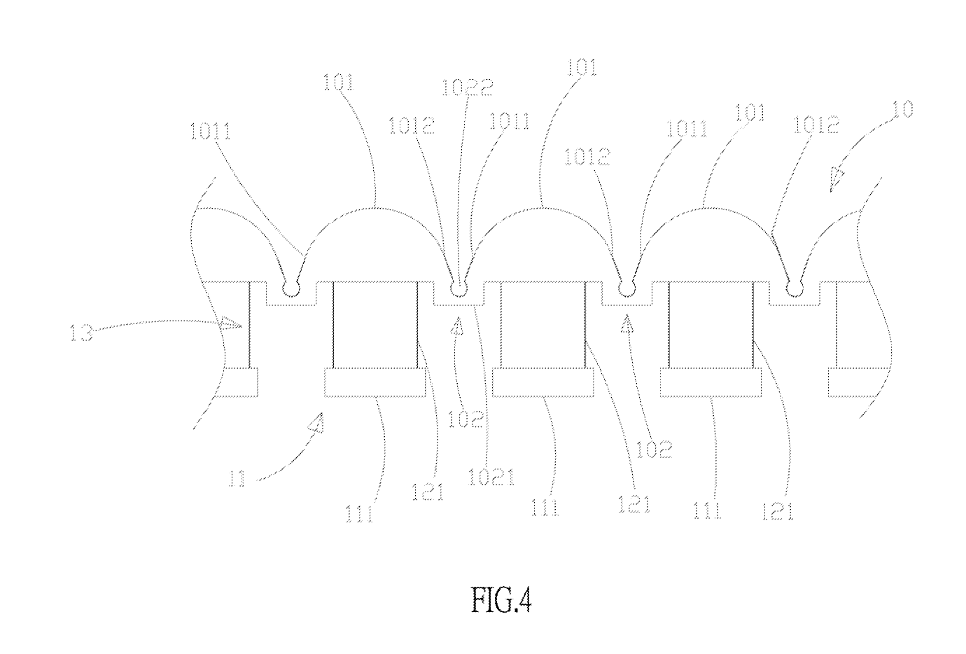

The first, protective body 101 according to the present embodiment has an inner surface 1013. The first side surface 1011 and the second side surface 1012 are oblique with respect, to the inner surface 1013 of the first protective body 101, respectively, and are symmetrical. The first protective body 101 according to the present embodiment is solid, with a trapezoidal, namely, quadrangular, cross-section. Of course, the cross-section of the first protective body 101 can be triangular, polygonal, or even semilunar or arched (refer to FIG. 4). It is only required that the first side surface 1011 and the second side surface 1012 of each first protective body 101 are oblique with respect to the inner surface 1013 of the first protective body 101 and symmetrical. The details will not be described further.

The plurality of connecting parts 102 of the first protective structure 10 are salient bars 1021, respectively. The crass-section of the salient bars 1021 according to the present embodiment are semilunar. Each salient bar 1021 has a groove 1022. Thereby, the thickness of the connecting parts 102 become thinner and thus reducing the rigidity of the plurality of connecting parts 102 and making the plurality of connecting parts 102 easy to bend, which, in turn, makes the first protective structure 10 easy to bend and hence avoiding limiting the bending radius of the protective device 1. The cross-section of the salient bars 1021 can be arched, or even triangular, quadrangular (refer to FIG. 4), or polygonal. The details will not be described further.

Refer again to FIG. 3. The second protective structure 11 includes a plurality of second protective bodies 111. Each second protective body 111 also has a first side surface 1111 and a second side surface 1112 corresponding to the first side surface 1111. The plurality of second protective bodies 111 are arranged linearly. Besides, there is gap between every two adjacent second protective bodies 111. The plurality of second protective bodies 111 are not interconnected. In addition, the plurality of second protective bodies 111 correspond to the plurality of first protective bodies 101, respectively. Of course, the plurality of second protective bodies 111 can be interconnected with a connection method identical to the one used in the plurality of first protective bodies 101. The details will not be described further.

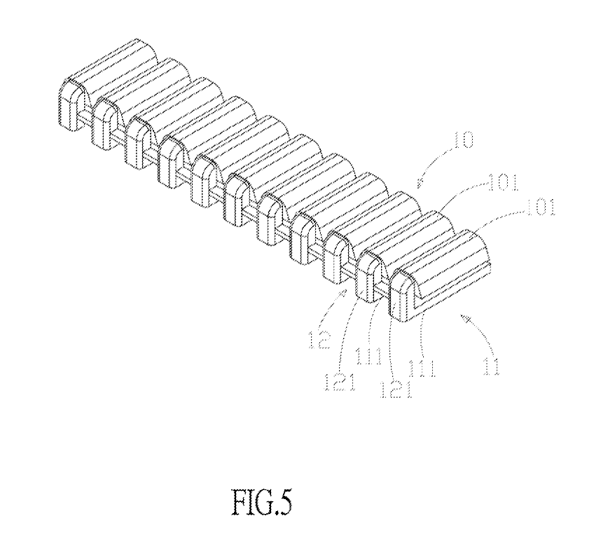

The connecting structure 12 has a plurality of connecting bodies 121. One end of each connecting body 121 is connected to an end of the corresponding first protective body 101 with the other end thereof connected to an end of the corresponding second protective body 111. Thereby, the plurality of second protective bodies 111 are connected with the plurality of first protective bodies 101 via the plurality of connecting bodies 121. In other words, the second protective structure 11 is connected with the first protective structure 10 via the connecting structure 12 so that the second protective structure 11 will not be separated from the first protective structure 10. The plurality of first protective bodies 101 described above are connected using the plurality of connecting parts 102. Alternatively, the plurality of connecting parts 102 may not be used. The plurality of connecting bodies 121 can be connected (refer to FIG. 5). The details will not be described further.

The end where the plurality of first protective bodies 101 connect with the plurality of connecting bodies 121 and the end where the plurality of second protective bodies 111 connect with the plurality of connecting bodies 121 are located on the same side. Thereby, the ends where the plurality of first protective bodies 101 and the plurality of second protective bodies 111 do not connect with the plurality of connecting bodies 121 form an inlet 13.

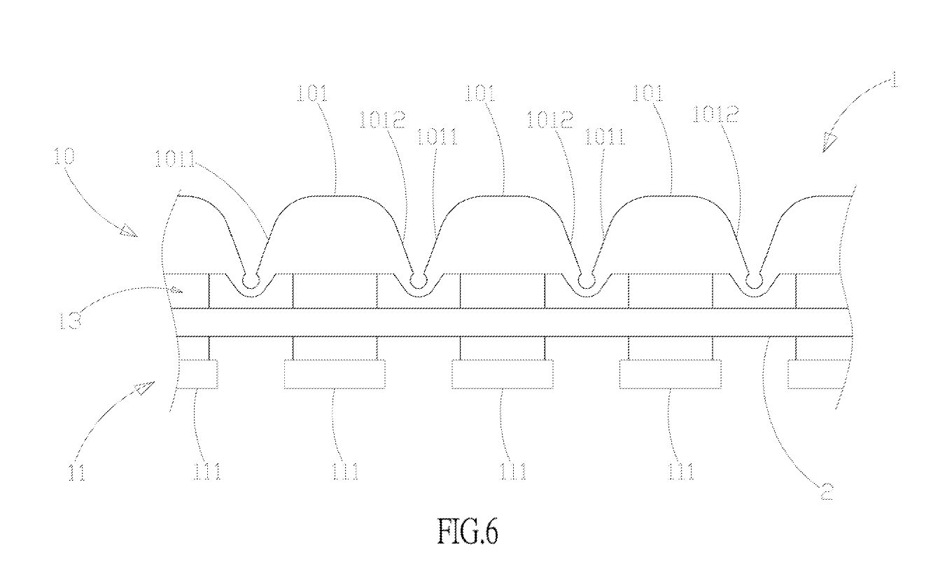

FIG. 6 shows a usage status diagram of the protective device according the first embodiment of the present disclosure. As shown in the figure, while disposing the protective device 1 on the flexible object 2, the flexible object 2 is inserted into the space between the plurality of first protective bodies 101 and the plurality of second protective bodies 111 from the inlet 13 located on the side of the protective device 1 (refer to FIG. 2) to make the plurality of first protective bodies 101 and the plurality of second protective bodies 111 cover the flexible object 2, Thereby, the -flexible object 2 is isolated from the exterior, avoiding accumulation of external pollutants on the flexible object 2. Pollution by the external pollutants can damage the flexible object 2. In addition, collisions between the flexible object 2 and external objects can be prevented as well. The collisions can also damage the flexible object 2. The material of the first and second protective structures 10, 11 is PP or nylon. When the first and second protective structures 10, 11 contact the flexible object 2, the flexible object 2 will not be scraped. Hence, the flexible object 2 can be protected with certainty. Besides, the inlet 13 according to the present embodiment is located on the side of the protective device 1. Thereby, when both ends of the flexible object 2 are connected with another device, it is not necessary to disassemble the flexible object 2 from the device. Instead, the flexible object 2 can be placed into the inlet 13 of the protective device 1, thus enhancing convenience in usage effectively.

When the flexible object 2 is disposed in the protective device 1 and the protective device 1 is bent by external force, the flexible object 2 bends according to the protective device 1. Please refer to FIG. 6. The first side surface 1011 of the first protective body 101 located at the center touches against the second side surface 1012 of the first protective body 101 located on the left; the second side surface 1012 of the first protective body 101 located at the center touches against the first side surface 1011 of the first protective body 101 located on the right. At this moment, the first protective structure 10 cannot be bent any more. That is to say, the bending radius of the first protective structure 10 has reached its minimum bending radius. The minimum bending radius of the first protective structure 10 is just the minimum bending radius of the protective device 1. Hence, the protective device 1 will not be bent any further as well.

The minimum bending radius of the protective device 1 is pre-configured according to the tolerable minimum bending radius of the flexible object 2, it can be equal to or greater than the minimum bending radius of the flexible object 2, The inclination of the first and second side surfaces 1011, 1012 of each first protective body 101 with respect to the inner surface 1012 of the first protective body 101 is determined according to the minimum bending radius of the protective device 1. In other words, the inclination of the first and second side surfaces 1011, 1012 of each first protective body 101 with, respect to the inner surface 1012 of the first protective body 101 is determined according to the tolerable minimum bending radius of the flexible object 2. Thereby, the minimum bending radius of the first protective structure 10 is greater than or equal to the tolerable minimum bending radius of the flexible object 2, and thus making the minimum bending radius of the protective device 1 greater than or equal to the tolerable minimum, bending radius of the flexible object 2. When the tolerable minimum bending radius of the flexible object 2 is smaller, the inclination of the first and second side surfaces 1011, 1012 of each first protective body 101 with respect to the inner surface 1012 of the first protective body 101 is smaller. On the contrary, when the tolerable minimum bending radius of the flexible object 2 is greater, the inclination of the first and second side surfaces 1011. 1012 of each first protective body 101 with respect to the inner surface 1012 of the first protective body 101 is greater.

Accordingly, when the protective device 1 cannot be bent any further, it means that the bending radius of the protective device 1 has reached its minimum bending radius. Because the tolerable minimum bending radius of the flexible object 2 is smaller than or equal to the minimum bending radius of the protective device 1, the flexible object 2 cannot be bent further and thus avoiding breaks or damages in the flexible object 2 due to over-bending.

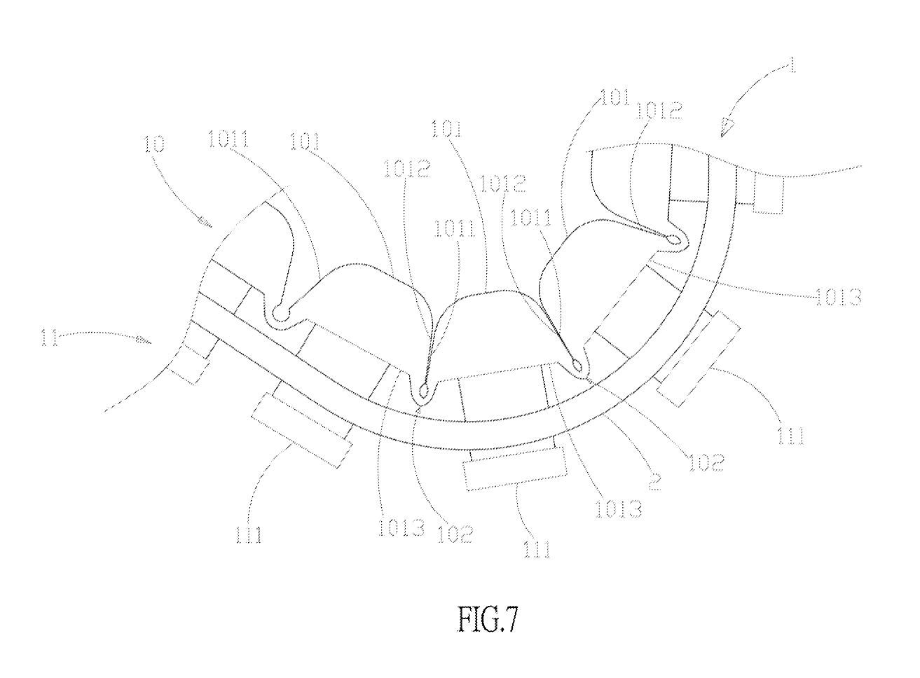

Refer to FIG. 7. According to the present embodiment, only the first and second side surfaces 1011, 1012 of each first protective body 101 are oblique with respect to the inner surface 1012 of the first protective body 101. Thereby, when the protective device 1 is bent by force, the first protective structure 10 has to be located on the inner side. The first protective structure 10 can be bent till the pre-designed minimum bending radius. Hence, the protective device 1 can be bent to the pre-designed minimum bending radius as well.

The plurality of first protective bodies 101 of the first protective structure 10 according to the present embodiment are connected via the plurality of connecting parts 102. Nonetheless, the plurality of second protective bodies 111 of the second protective structure 11 are not interconnected. Thereby, when the first protective structure 10 bends, the second protective structure 13 also bends according to the first protective structure 10. Because the bending radius of the second protective structure 11 is greater than that of the first protective structure 10, the extension length of the second protective structure 11 needs to be greater than that of the first protective structure 10. If the plurality of second protective bodies 111 of the second protective structure 11 are interconnected, the extensibility of the second protective structure 11 will be inferior, limiting the bending radius of the protective device 1. Consequently, the pre-designed minimum bending radius can never be reached, and thus disabling the possibility of disposal of the protective device 1 on a bent flexible object 2. Thereby, the plurality of second protective bodies 111 according to the present embodiment are not interconnected. The plurality of second protective bodies 111 are extended according to the bending of the first, protective structure 10. The plurality of second protective bodies 111 will not influence each other, and hence making the bending radius of the protective device 1 not limited and capable of being bent to the pre-designed minimum bending radius. So, the protective device 1 can be disposed on the bent flexible object 2.

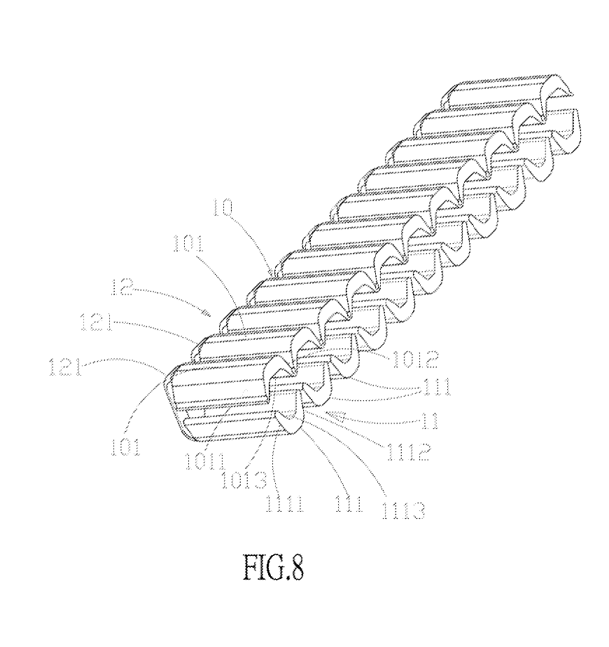

FIG. 8 shows a three-dimensional diagram of the protective device according a fourth embodiment of the present disclosure. As shown in the figure, only the first and second side surfaces 1011, 1012 of the first protective body 101 of the first protective structure 10 are oblique with respect to the inner surface 1013 of the first protective body 101 according to the previous embodiment. Nonetheless, according to the present embodiment, the first and second side surfaces 1111, 1112 of the second protective body 111 of the second protective structure 11 are also oblique with respect to the inner surface 1113 of the second protective body 111 and symmetrical to each other. Besides, the inclination of the first and second side surfaces 1111, 1112 of the second protective body 111 with, respect to the inner surface 1113 of the second protective body 111 depends on the tolerable minimum bending radius of the flexible object. When the protective device 1 is bent by force, the first or second protective structure 10, 11 is bent on the inner side and making the protective device 1 reach the pre-designed minimum bending radius. Namely, the protective device 1 can be bent in two directions can reach the pre-designed minimum bending radius.

The first and second protective body 101, 111 according to the present embodiment are hollow with a U-shape cross-section. When the protective device is bent by external force, thanks to their excellent extensibility, the rigidity of the plurality of first protective bodies 101 and the plurality of second protective bodies 111 is reduced. Consequently, the plurality of first protective bodies 101 and the plurality of second protective bodies 111 can further attach to the surface of the flexible object and protect the flexible object very well. Of course the first and second protective bodies 101, 111 can be V-shaped or arched. The details will not be described further.

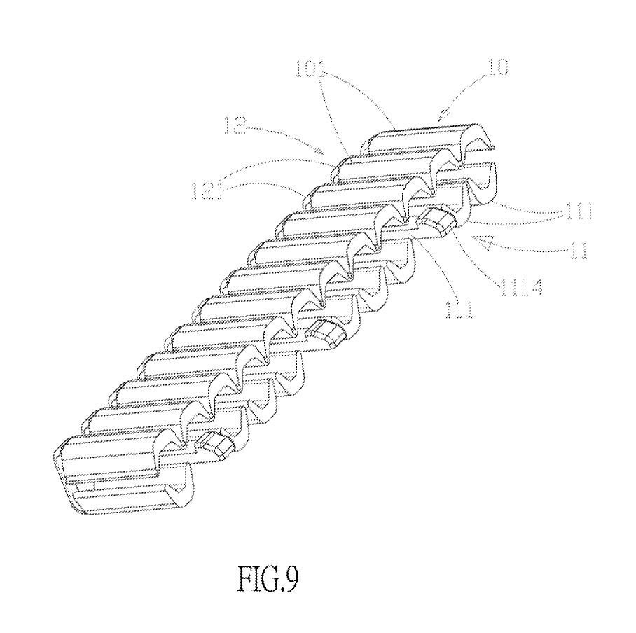

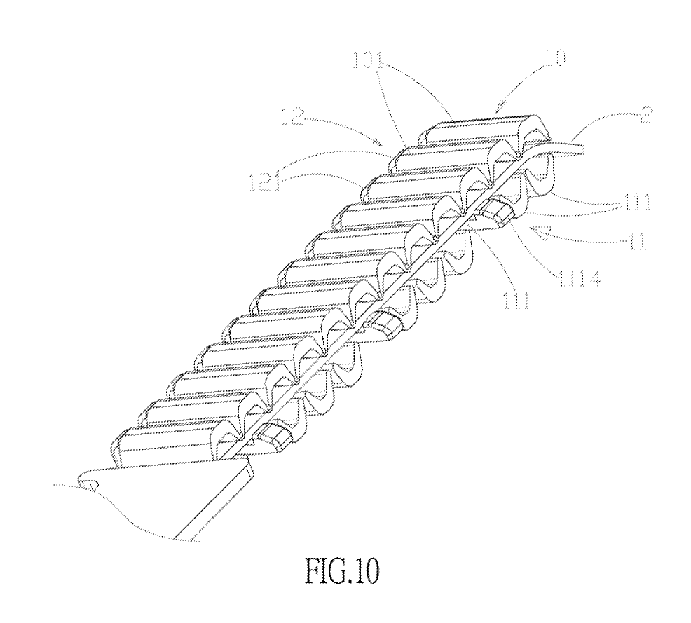

FIG. 9 and FIG. 10 show a three-dimensional diagram and a usage status diagram of the protective device according a fifth embodiment of the present disclosure. As shown in the figures, the difference between the protective device 1 according to the present embodiment and the one according to the previous embodiment is on the second protective structure 11. The end of the plurality of protective bodies 111 not connecting with the connecting body 121 further has a blocking part 1114 opposite to the connecting body 121. The second protective body 111 having the blocking part 1114 has a rectangular cross-section. When, the flexible object 2 is placed into the space between the first and second protective structures 10, 11, the blocking part 1114, which is a salient member, can block the flexible object 2 and prevent the flexible object 2 from coming off the space between the first and second protective structures 10, 11.

To sum up, the present disclosure relates to a protective device for protecting flexible objects. The protective device covers the flexible object for avoiding collisions, and hence damages, of the flexible object with other objects. It also prevents external pollutants from polluting and damaging the flexible object. The protective device can bend according to the bending of the flexible object. It also prevents the bending radius of the flexible object greater than the tolerable minimum bending radius of the flexible object. Thereby, breaks or damages in the flexible object due to over-bending can be avoided. In addition, the protective device can be disposed directly on the flexible object when the flexible object is connecting with other devices. Alternatively, the flexible object having the protective device installed can be disassembled from or inserted into the other device directly. Consequently, the protective device brings superior convenience in usage.

Accordingly, the present disclosure conforms to the legal, requirements owing to its novelty, nonobviousness, and utility. However, the foregoing description is only embodiments of the present disclosure, not used to limit the scope and range of the present disclosure. Those equivalent changes or modifications made according to the shape, structure, feature, or spirit described in the claims of the present disclosure are included in the appended claims of the present disclosure.

1. A protective device, used for covering a flexible object, comprising:
a first protective structure, including a plurality of first protective bodies;
a second protective structure, including a plurality of second protective bodies, corresponding to said plurality of first protective bodies; and
a connecting structure, connecting said first protective structure and said second protective structure;
where said first protective structure has a minimum bending radius greater than or equal to the minimum bending radius of said flexible object.

2. The protective device of claim 1, wherein, each said first protective body has a first side surface, a second side surface corresponding to said first side surface, and an inner surface, and said first side surface and said second side surface are oblique with respect to said inner surface, respectively, and symmetrical to each other.

3. The protective device of claim 2, wherein the inclination of said first side surface and said second side surface of said first protective body with respect to said inner surface depends on said minimum bending radius of said flexible object.

4. The protective device of claim 1, wherein said connecting structure includes a plurality of connecting bodies connected to an end of the corresponding first protective body and an end of the corresponding second protective body.

5. The protective device of claim 4, wherein said first protective structure further includes a plurality of connecting parts located between said plurality of first protective bodies, respectively, and connecting said plurality of first protective bodies.

6. The protective device of claim 5, wherein each said connecting part is a salient bar with a semilunar, arched, triangular, or polygonal cross-section.

7. The protective device of claim 6, wherein said salient bar further has a groove.

8. The protective device of claim 5, wherein said plurality of first protective bodies and said plurality of connecting parts are formed, integrally,

9. The protective device of claim 1, wherein said connecting structure includes a plurality of connecting bodies connected to an end of the corresponding first protective body and an end of the corresponding second protective body and interconnected to each other.

10. The protective device of claim 1, wherein each said first protective body or each said second protective body is solid with a triangular, quadrangular, polygonal, semilunar, or arched cross-section.

11. The protective device of claim 1, wherein each said first protective body or each said second protective body is hollow with a V-shaped, U-shaped, or arched cross-section.

12. The protective device of claim 1, wherein each said second protective body has a first side surface, a second side surface corresponding to said first side surface, and an inner surface, and said first side surface and said second side surface are oblique with respect to said inner surface, respectively.

13. The protective device of claim 12, wherein the inclination of said first side surface and said second side surface of said second protective body with respect to said inner surface depends on said minimum bending radius of said flexible object.

14. The protective device of claim 1, wherein at least one of said plurality of second protective bodies further includes a blocking part disposed on an end of said second protective body and opposite to said connecting structure.
